(19) United States
(12) Patent Application Publication
(10) Pub. No.: US 2011/0242590 A1
(43) Pub. Date: Oct. 6, 2011

(54) IMAGE FORMING APPARATUS AND IMAGE FORMING METHOD

(75) Inventor: Kazunobu Takahashi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/045,758

(22) Filed: Mar. 11, 2011

Related U.S. Application Data
(60) Provisional application No. 61/320,915, filed on Apr. 5, 2010.

(51) Int. Cl. G06F 3/12; G06K 15/02

(52) U.S. Cl. 358/1.15; 358/1.16

(57) ABSTRACT

According to one embodiment, an image forming apparatus includes an erase designating unit configured to designate an intensity value of overwrite erase for each data or each job unit as a method of erasing unnecessary data that is written in a storage device, and an overwrite erasing unit configured to overwrite and erase the data according to the designated intensity value by the erasing method.

### CROSS-REFERENCE TO RELATED APPLICATIONS

This application is based upon and claims the benefit of U.S. Provisional Application No. 61/320,915, filed on Apr. 5, 2010; the entire contents of which are incorporated herein by reference.

### FIELD

Embodiments described herein relate generally to an image forming apparatus and an image forming method.

### BACKGROUND

Up to now, there has been known an image forming apparatus (MFP: multifunction peripheral) having a security function of erasing data that has been stored once, for the purpose of preventing information leak.

In the image forming apparatus, data used for a job is temporally stored in a storage area of a magnetic storage device such as a hard disk device, and read in timing when processing is conducted. After processing, management information called “FAT (file allocation table)” that manages the data is updated. However, because the data per se is not erased, and remains in the storage area, security may be problematic.

Under the circumstances, a technique has been proposed by which the data area is overwritten by a given pattern or a random pattern image. Further, from the viewpoint that one overwrite is insufficient for a data erasing effect, there has been also proposed a technique by which an area in which the data has been stored is repetitively subjected to erasing operation.

Data confidence is improved by repetitively conducting the easing operation. On the other hand, when the erasing operation is repeated, an access to the hard disk device increases with the result that the performance is deteriorated.

### BRIEF DESCRIPTION OF THE DRAWINGS

FIG. 1 is an exemplary perspective view illustrating a general configuration of an image forming apparatus according to this embodiment;

FIG. 2 is an exemplary block diagram illustrating a configuration of a control system of an MFP according to this embodiment;

FIG. 3 is an exemplary external view of a control panel disposed in the MFP according to this embodiment;

FIG. 4 is an exemplary diagram illustrating how to store image data in an HDD in the image forming apparatus according to this embodiment;

FIG. 5 is an exemplary diagram illustrating an erase information setting input screen in the image forming apparatus according to this embodiment;

FIG. 6 is an exemplary diagram illustrating the general contents of a secure erase setting DB according to this embodiment;

FIG. 7 is a flowchart showing an erasing procedure in the image forming apparatus according to this embodiment;

FIG. 8 is a flowchart showing a procedure of checking a type of the data to be erased according to this embodiment; and

FIG. 9 is an exemplary diagram illustrating a user request erase information setting input screen in the image forming apparatus according to this embodiment.

### DETAILED DESCRIPTION

In general, according to one embodiment, an image forming apparatus includes an erase designating unit that designates an intensity value of overwrite erase for each data or each job unit as a method of erasing unnecessary data that is written in a storage device; and an overwrite erasing unit that overwrites and erases the data according to the designated intensity value by the erasing method.

Hereinafter, an image forming apparatus (hereinafter referred to as “MFP (multifunction peripheral)”) 201 will be exemplified in an embodiment of the present invention.

The MFP 201 is directed to a digital multifunction peripheral for comprehensively utilizing functions of various office devices such as not only functions for scanning and reading or copying an image with a designated resolution or paper size, but also an image receive function by a FAX, an image receive function by an e-mail, and a print image receive function by a network.

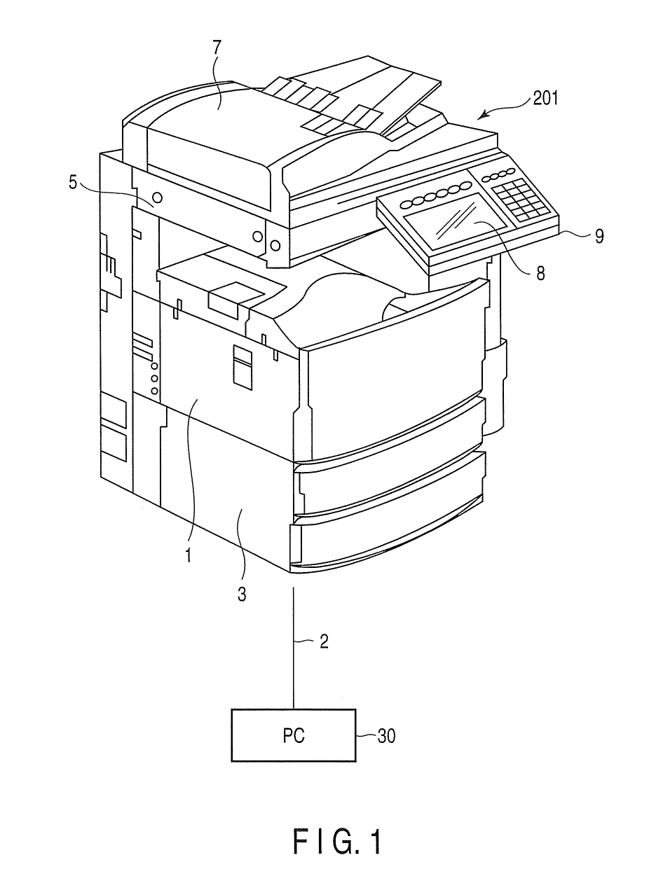

FIG. 1 is an exemplary perspective view illustrating a general configuration of an image forming apparatus according to this embodiment. The MFP 201 is connected to a personal computer (PC) 30 over a network 2.

The MFP 201 includes a print unit 1, a paper tray 3, a scan unit 5, an auto feed unit 7, and a control panel 9 with a display unit 8.

The print unit 1 outputs image information as an output image which is called, for example, “hardcopy” or “printout”. The paper tray 3 supplies an output medium which is a sheet of an arbitrary size used for image output to the print unit 1. The scan unit 5 retrieves the image data from an original document as the image data. The auto feed unit 7 discharges the original document from which the image information has been retrieved from a read position to a discharge position, and guides a next original document to the read position. The control panel 9 is an instruction input unit for instructing the operation of the MFP 201 such start of image formation in the print unit 1 or start of reading the image information of the original document by the scan unit 5. The control panel 9 is equipped with the display unit 8 for inputting instructions and displaying information for an operator.

Further, the MFP 201 is connected to a network or a communication line so as to receive the image data through a FAX and an e-mail.

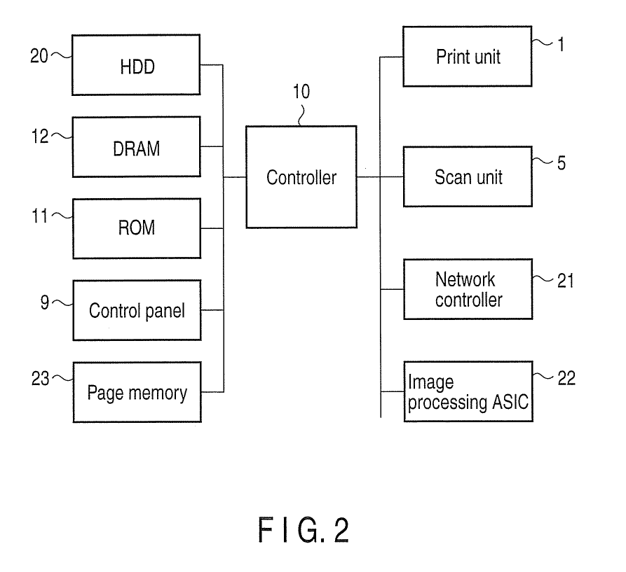

FIG. 2 is an exemplary block diagram illustrating a configuration of a control system of the MFP 201 according to this embodiment.

The MFP 201 further includes a ROM 11, a DRAM 12, an internal storage device (HDD) 20, a network controller 21, an image processing ASIC 22, and a page memory 23 together with the print unit 1, the paper tray 3, the scan unit 5, the display unit 8, the control panel 9, and a controller 10. Those respective components are connected to each other through a system bus.

The controller 10 controls the respect components connected thereto through the system bus. The ROM 11 stores various control programs necessary for operating the MFP 201 therein. In the ROM 11 are stored respective programs for controlling overwrite erasing operation that will be described later. The execution of the respective programs is controlled by the controller 10. The DRAM 12 is a buffer memory that temporarily stores the data occurring at the time of executing the respective programs therein. The DRAM 12 is a volatile memory in which the data stored therein is cleared by turning off a power supply.

The network controller 21 communicates information through the network such as the internet. The HDD 20 is a nonvolatile storage medium located within the MFP 201, in which the data stored therein is not cleared even by turning off the power supply.

The image processing ASIC 22 conducts image processing such as tone correction or color conversion on a scanned image. The page memory 23 stores an image for each page to be printed therein.

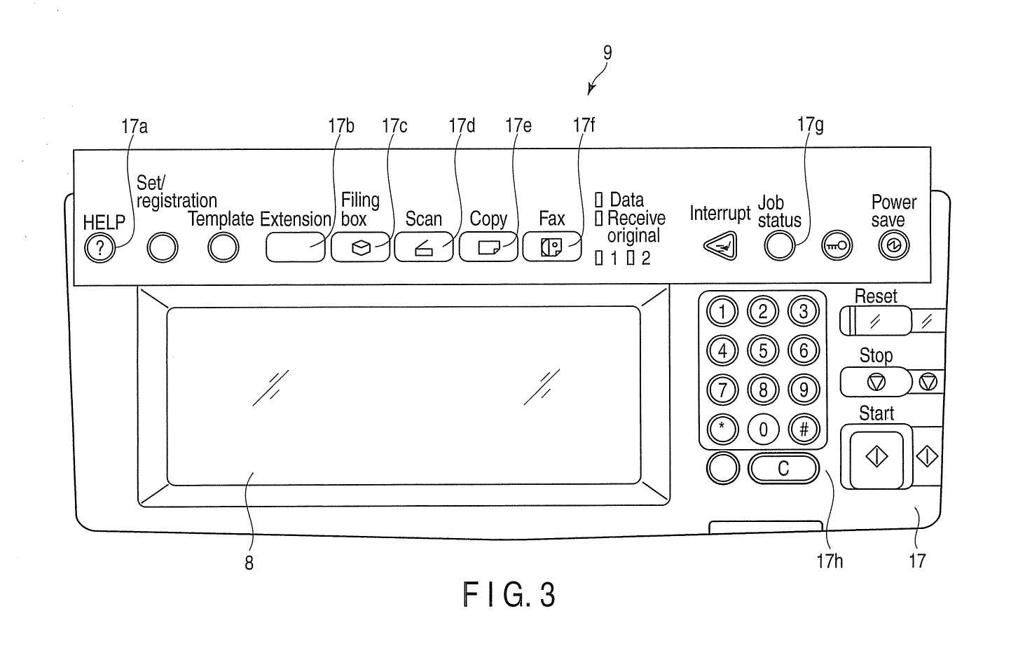

FIG. 3 is an exemplary external view of the control panel 9 disposed in the MFP 201 according to this embodiment. The setting and confirmation of the MFP 201 are conducted by the user through the control panel 9. The control panel 9 is equipped with the display unit 8 and an operation unit 17. The display unit 8 is configured by a touch panel, and displays a state of the MFP 201, an operation procedure, and various instructions for the user thereon. The operation unit 17 is provided with various operation buttons for operating the MFP 201.

Keys for selecting any function and calling up a setting screen, there are arranged a help button 17a, an extension button 17b, a filing box button 17c, a scan button 17d, a copy button 17e, a fax button 17f, and a status confirmation button 17g. In addition, a numeric keypad 17h for inputting a set value and confirming information are also arranged.

The functions of main buttons among those operation buttons will be described. The operation unit 17 is used in querying next operation. The extension button 17b is operated in using an extension function. The filing box button 17c is used in extracting saved image data. The scan button 17d is used in using a scan function. The copy button 17e is used in using a copy function. The fax button 17f is used in using a fax function. The status confirmation button 17g is used in executing private print. The numeric keypad 17h is used in inputting numeral.

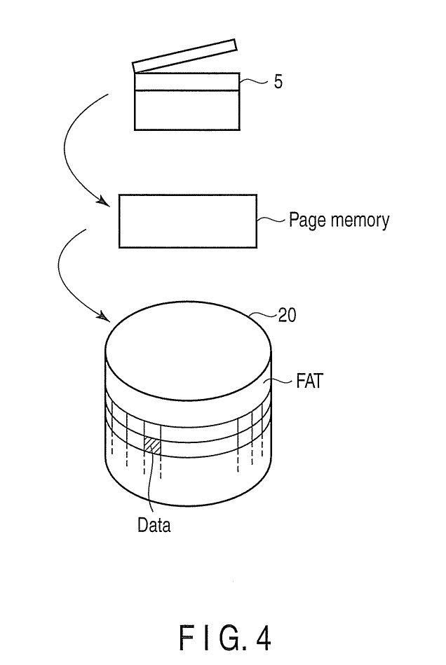

FIG. 4 is an exemplary diagram illustrating how to store the image data in the HDD 20 in the image forming apparatus 201 according to this embodiment.

For example, the image data read by the scan unit 5 is stored in a page memory, and also subjected to image processing by the image processing ASIC 22 and stored in the HDD 20. If the image data is stored in the HDD 20, a management table indicative of information on an area in which the image data is stored is referred to. For example, the image data is stored in a second storage area indicated by allocation data in an FAT (file allocation table) which is a management table in a first storage area of the HDD 20. The management table is not limited to the FAT.

Now, a background of arriving at a proposal of the following erasing method according to the present invention will be described. As usual, actual data such as image data is stored on an area allocated to the storage area. A file system that manages the actual data has a function of associating a write target area of the actual data with a virtual directory tree. In the conventional normal erasure, the actual data is not deleted but the above association is deleted. However, in the above association deletion, because the actual data exists on the storage area, the data can be easily reacquired by a malicious third party. Accordingly, the actual data is overwritten with another data so that a risk that information is leaked by the above re-acquirement can be reduced. However, because the risk that the data is salvaged remains with only one overwrite, the number of overwrite and the overwrite system are more enhanced so that the risk of the salvage can be reduced. However, because a high-level overwrite erasing system occupies a resource (mainly HDD), the performance is deteriorated.

Subsequently, the erasing operation in the MFP 201 will be described. The erasing modes of the MFP 201 are two kinds of a normal erase mode and a secure erase mode. In this example, the secure erase mode is a mode of executing the erase operation by overwrite erase.

In the normal erase mode, only the allocation data of the FAT is erased. In the secure erase mode, used image data remaining in the HDD 20 is overwritten and erased, and the corresponding allocation data is deleted.

Further, in the secure erase mode, intensity for erasing the actual data has, for example, three levels. In a low (L) level, overwrite erase of one cycle having the combination of overwrite erase using data “0”, overwrite erase using data “F”, and overwrite erase using random data is repetitively implemented three times (3 cycles). In a middle (M) level, the overwrite erase of the above one cycle is repetitively implemented five times (5 cycles). In a high (H) level, the overwrite erase of the above one cycle is repetitively implemented seven times (7 cycles).

In the image forming apparatus 201 according to this embodiment, a mode for erasing a job to be executed and data to be used can be designated.

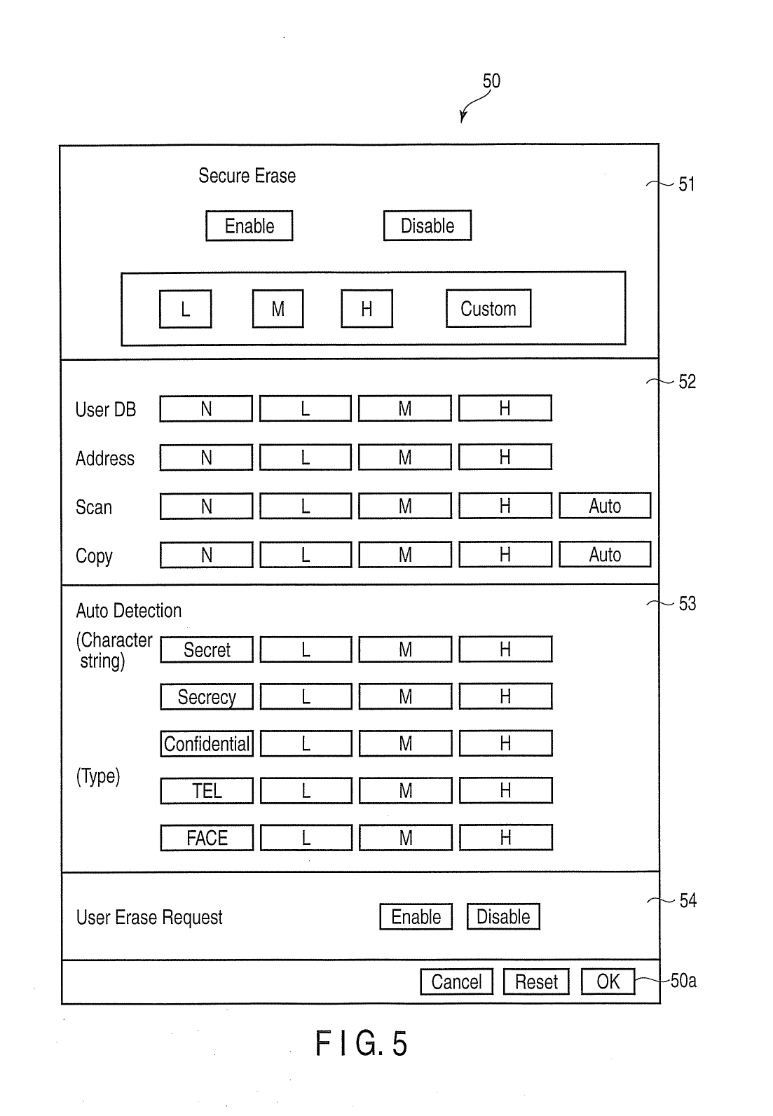

FIG. 5 is an exemplary diagram illustrating an erase information setting input screen 50 in the image forming apparatus 201 according to this embodiment. The erase information setting input screen 50 is displayed on the display unit 8 of the control panel 9, and setting is input through a touch panel. The erase information setting input screen 50 is provided with an erase mode designation area 51, a job data designation area 52, a detail data designation area 53, and a manager designation area 54. The manager designation area 54 will be described later.

Whether the secure erase mode is made effective, or not, can be set from the erase mode designation area 51. When “enable” is selected, the secure erase mode becomes effective, and the operation of a detail designation area 51a is enabled. The detail designation area 51a is provided with “L”, “M”, and “H” buttons for designating the intensities of the secure erase mode, and a “custom” button. When the “L”, “M”, and “H” buttons are depressed, the erase mode intensity level is determined according to a designated value in the image forming apparatus 201. When the “custom” button is depressed, the erase mode intensity level can be set by buttons in the job data designation area 52 and the detail data designation area 53. When “disable” is selected, only the normal erase mode becomes effective in the image forming apparatus 201. That is, buttons in the job data designation area 52 and the detail data designation area 53 cannot be used.

In the job data designation area 52, the erase mode can be designated for each job and each data.

Data that can designate the erase mode includes “user DB” and “address”. The “user DB” is a user management table, which may include individual information. The “address” is information that is registered and used as FAX and e-mail destinations, which may include individual information. As a case in which those data is erased, there is a case in which the user leaves his job, or cooperation leaves a society, and the manager erases associated data. If the normal erase mode is designated for the above data, “N” is selected, and if the secure erase mode is designated, its intensity “L”, “M”, or “H” is selected.

A job that can designate the erase mode includes “scan” and “copy”. The scan job is a process of subjecting data read by the scan unit 5 to image processing to generate the image data. The copy job is a process of recording the data read by the scan unit 5 on a medium. If the data used for those jobs is erased, the above-mentioned “N”, “L”, “M”, and “H” as well as “AUTO” can be selected. If “AUTO” is selected, the erase mode can be designated for each specific character string or each specific pattern included in the data. A character included in the data may be a character obtained by recognizing the data read by, for example, an OCR (optical character reader) through character recognition.

In the detail data designation area 53, the intensity of the secure erase mode can be designated for each specific character string or each specific pattern included in the data. As the specific character strings, “secret”, “secrecy”, or “confidential” can be designated. As the specific pattern, “TEL” and “FACE” can be designated. The pattern “TEL” represents that information determined as telephone number is included in the data. The pattern “FACE” represents that information determined as a face image is included in the data. If the face is extracted, it can be determined that the data is high in confidentiality for the reason that the possibility of an identification card is high.

Also, “AUTO”, “L”, “M”, and “H” can be designated at the same time. When those intensities are designated at the same time, if no specific character is not included in the data, “normal” is not selected, but the erase level designated by the user is applied.

Alternatively, not depending on “AUTO”, the specific character string or character pattern “for example, regular expression is used” may be arbitrarily designated by the user, and the intensity level of the secure erase mode can be designated for each specific character string.

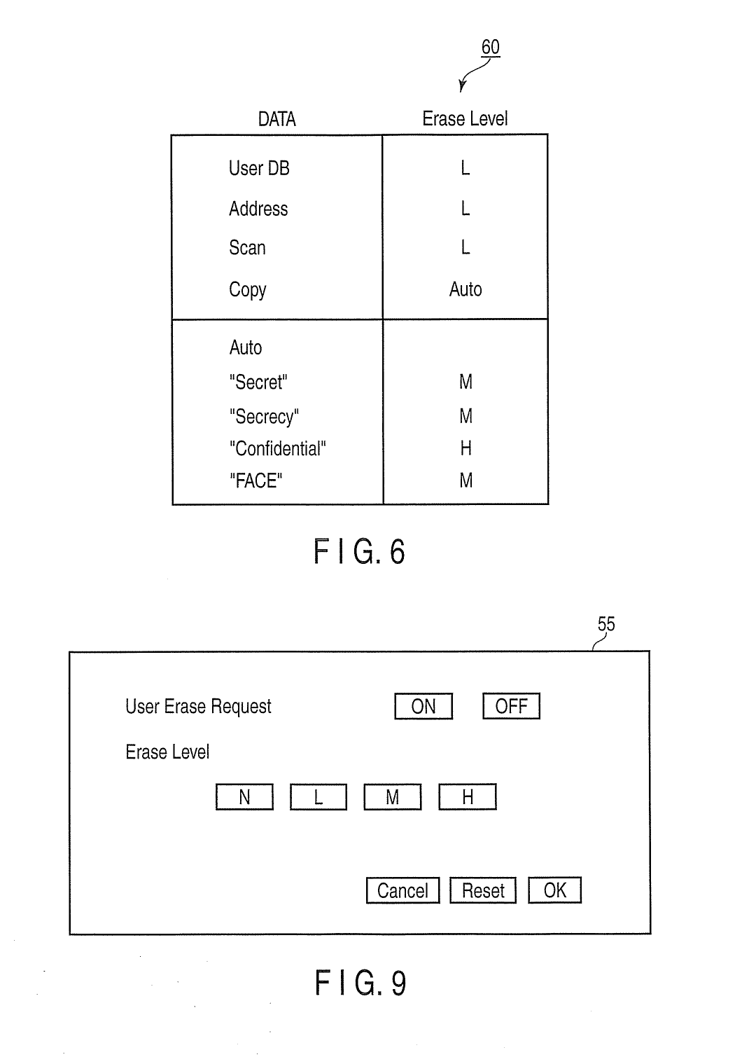

The information set in the erase information setting input screen 50 is saved in the HDD 20 of the image forming apparatus 201. In particular, the information set in the job data designation area 52 and the detail data designation area 53 is stored in a secure erase setting DB 60. FIG. 6 is an exemplary diagram illustrating the general contents of the secure erase setting DB 60 according to this embodiment. In this example, the secure erase setting DB 60 is stored in the HDD 20. In FIGS. 5 and 6, the setting data of AUTO is common to each other. However, the data of AUTO can be set for each job, individually.

The setting of the intensity level is not limited to the above-mentioned system. A method of designating the erasing system for each of “L”, “M”, and “H” can be designated by the user with the use of a well-known method.

Also, a lowermost stage of the erase information setting input screen 50 is provided with an area 50a having buttons for making the above-mentioned respective settings effective or ineffective.

Subsequently, the erasing operation in the image forming apparatus 201 will be described.

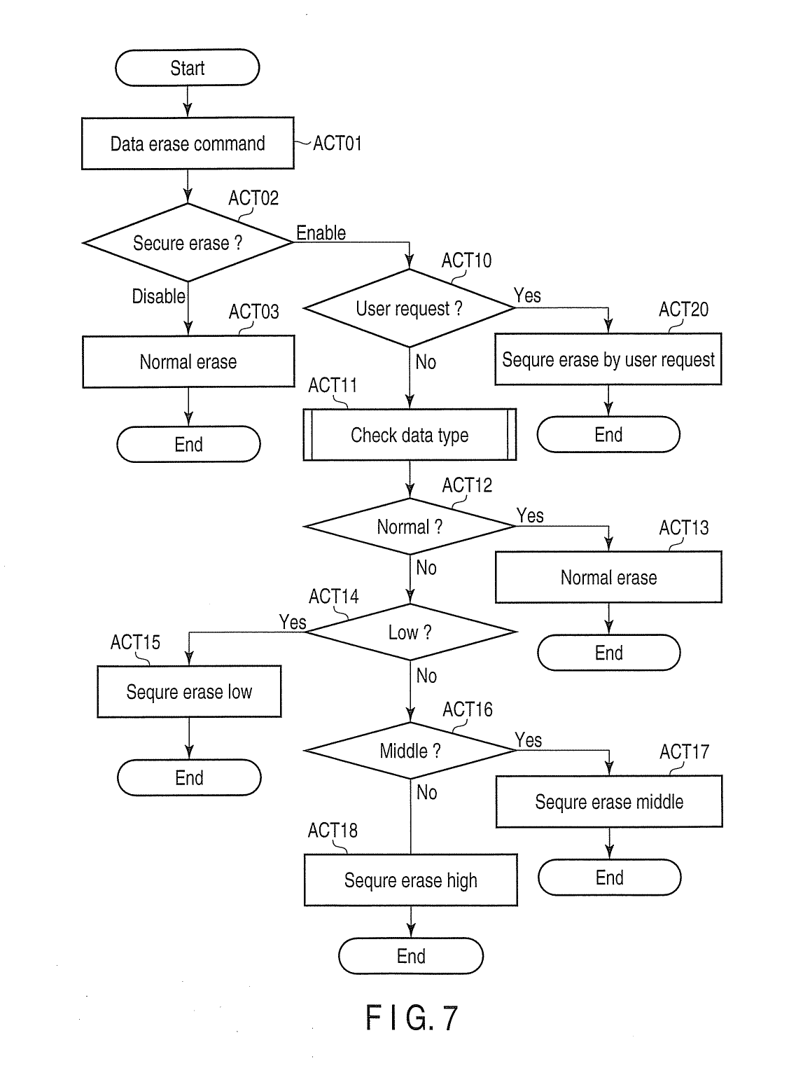

FIG. 7 is a flowchart showing an erasing procedure in the image forming apparatus 201 according to this embodiment. The operation shown in FIG. 7 is executed by the controller 10.

In ACT 01, the controller 10 receives a data erase instruction. The data erase instruction is automatically or manually instructed. For example, if copy operation is executed, erasing of the image data in the HDD 20 is automatically executed at a time when the print output of the image data has been completed. In the above example, the erase operation automatically executed corresponds to the copy operation and the scan operation. Also, when the operation of erasing the designated data is conducted from the control panel 9 or an external terminal such as a web UI (user interface), the data is erased in correspondence with the manual operation. The operation of manually executing the erase corresponds to erasing of the user DB and the address data in the above example.

In ACT 02, the controller 10 checks whether the secure erase mode is effective, or not. If the secure erase mode is not effective (disable in ACT 02), the controller 10 executes the erasing operation in the normal erase mode in ACT 03.

If the secure erase mode is effective (enable in ACT 02), the controller 10 checks whether the erase is requested by the user, or not, in ACT 10. The erase requested by the user will be described in detail later. If the erase is not requested by the user (no in ACT 10), the controller 10 checks a type of the data to be erased, and executes the operation of determining the erase level in ACT 11.

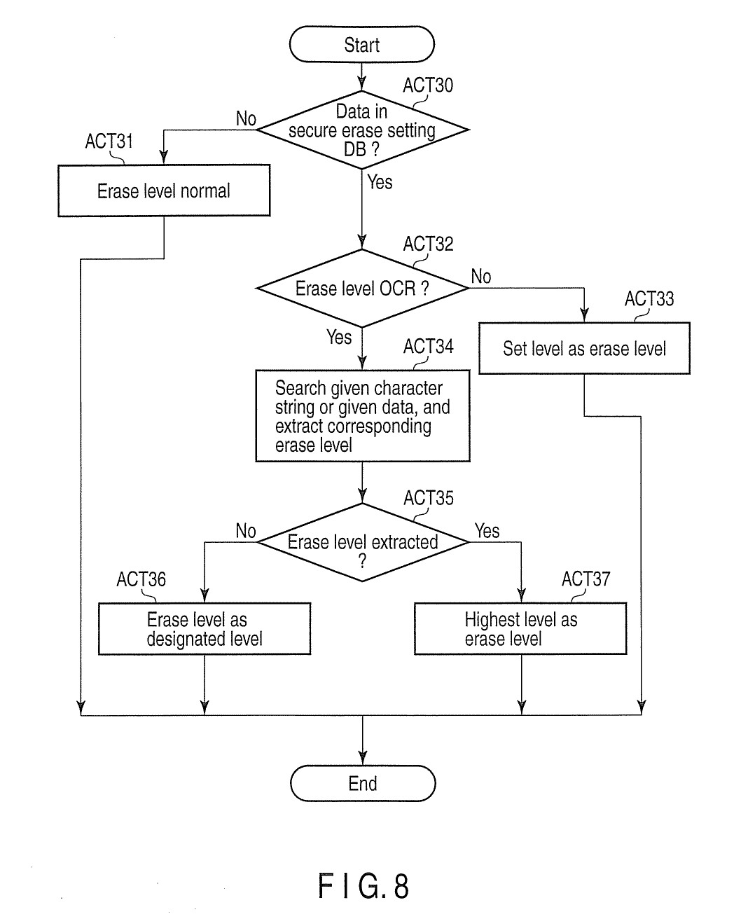

FIG. 8 is a flowchart showing a procedure of checking a type of the data to be erased according to this embodiment. In this processing, the controller 10 extracts the erase level of the data to be erased.

In ACT 30, the controller 10 searches the secure erase setting DB 60, and checks whether the data to be erased has been registered, or not. If the data to be erased is not registered (no in ACT 30), the controller 10 sets the erase level to normal in ACT 31.

If the data to be erased is registered (yes in ACT 30), the controller 10 checks whether the level set in the data to be erased is “AUTO”, or not, in ACT 32. If the level is not AUTO (no in ACT 32), the controller 10 sets the erase level to the set level (L, M, H).

If the level is AUTO (yes in ACT 32), the controller 10 searches the secure erase setting DB 60, and checks the detail designation data in AUTO in ACT 34. If the designated character string or the designated data exists in the data to be erased, the controller 10 extracts the level (L, M, H).

In ACT 35, the controller 10 checks whether the level has been extracted, or not. If the level has been extracted (yes in ACT 35), the controller 10 sets the highest level in the extracted levels to the erase level in ACT 37. If the level has not been extracted (no in ACT 35), the controller 10 sets the erase level to the designated level in ACT 36. If the erase level is not designated, the controller 10 sets the erase level to normal.

In the flowchart of FIG. 7, if the erase level is normal (yes in ACT 12), the controller 10 executes the operation of erasing the data to be erased in the normal erase mode in ACT 13. If the erase level is low (yes in ACT 14), the controller 10 executes the operation of erasing the data to be erased in the low level of the secure erase mode in ACT 15. If the erase level is middle (yes in ACT 16), the controller 10 executes the operation of erasing the data to be erased in the middle level of the secure erase mode. If the erase level is high (no in ACT 16), the controller 10 executes the operation of erasing the data to be erased in the high level of the secure erase mode in ACT 18.

Subsequently, erase requested by the user as described in ACT 10 will be described. The user can set the erasing operation in a job when the job is executed. The setting is effective only in the job, and gets preference over erase based on the above-mentioned secure erase setting DB 60.

FIG. 9 is an exemplary diagram illustrating a user request erase information setting input screen 55 in the image forming apparatus 201 according to this embodiment. The user can set erase in the user request erase information setting input screen 55 before inputting a job start in the setting of the job.

The user selects the erase level from N (normal erase), L (secure erase low level), M (secure erase middle level), and H (secure erase high level). Then, the user turns on a user erase request, and selects OK, thereby enabling the selection to be effective.

The level settable by the user is effective only when the level is higher than that set to a machine body by the manager. Also, the user erase request is effective when the manager authorizes the user to operate the user erase request. That is, the manager sets whether to authorize the user to operate the user erase request, or not.

In ACT 10 of a flowchart in FIG. 7, the controller 10 checks whether erase is requested by the user, or not. If the erase is requested by the user (yes in ACT 10), the controller 10 executes the erasing operation according to the contents set in the user request erase information setting input screen 55 in ACT 20.

In the above-mentioned embodiment, information is set from the erase information setting input screen 50 displayed on the control panel 9. Alternatively, the setting may be conducted by a PC connected to the image forming apparatus 201 through the network controller 21. Also, the secure erase setting DB 60 may be saved in the above-mentioned PC so that the image forming apparatus 201 appropriately refers to the secure erase setting DB 60. With provision of the above function to the PC, the operability for inputting the setting is improved, and detailed erase modes can be set.

In the above-mentioned embodiments, the number of overwrite is changed according to the erase level. However, the present invention is not limited to this configuration, but a type of overwrite pattern data, the number of overwrite, and combination thereof may be changed according to the erase level. That is, an intensity value in which complexity of overwrite is changed may be designated according to the erase level. Accordingly, it is needless to say that the number of erase level is not limited to three.

In the above-mentioned embodiment, the intensity of overwrite erase is designated for each data or each job unit. However, the present invention is not limited to this configuration, but the intensity of overwrite erase may be designated for each data type or each job type. Also, the intensity of erase may be designated by combination of those elements.

The image forming apparatus according to the above-mentioned embodiment has the remarkable advantages as compared with the related art.

The image forming apparatus according to this embodiment can designate the intensity of overwriting at the time of erasing the data for all of information stored internally, for example, the image data or address book data. Also, the image forming apparatus can extract the specific character string included in information, for example, “secret”, “secrecy”, or “confidential” from binary of the data, a header portion, automated text data, and automatically determine the intensity of overwriting at the time of erasing the data. Further, the image forming apparatus can extract the face image through image processing, and automatically determine the intensity of the overwriting at the time of erasing the data. In addition, user can designate the intensity of the overwriting.

Accordingly, in the image forming apparatus according to this embodiment, the performance can be prevented from being deteriorated while improving the confidence in a mode appropriate to information. Also, an imposition on the user can be reduced, and the overwrite erase of the data can be implemented in detail and flexibly, and also implemented efficiently.

The respective functions described in the above-mentioned embodiments may be configured by hardware, and a program describing the respective functions with the help of software may be read and realized by a computer. Also, the respective functions may be configured by appropriately selecting any one of software and hardware.

Further, the respective functions can be realized by allowing a computer to read a program stored in a recording medium not shown. The recording medium in this embodiment may be of any recording format if the recording medium can record the program and is readable by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an erase designating unit configured to designate an intensity value of overwrite erase for each data or each job unit as a method of erasing unnecessary data that is written in a storage device; and
an overwrite erasing unit configured to overwrite and erase the data according to the designated intensity value by the erasing method.

2. The apparatus according to claim 1, further comprising:
a character string searching unit configured to search whether at least one given character string is included in the data, or not,
wherein the erase designating unit further designates an intensity value of overwrite erase for each given character string included in the data, and
wherein the overwrite erasing unit erases the data through the erasing method according to the highest intensity value in the intensity values of overwrite erase for each plural given character strings included in the data.

3. The apparatus according to claim 2,
wherein the character string can be arbitrarily added.

4. The apparatus according to claim 2,
wherein the character string includes at least one of secret, secrecy, and confidential.

5. The apparatus according to claim 4,
wherein the overwrite erasing unit changes at least one of a type of overwrite pattern data, the number of overwrite, and combination thereof according to the intensity value.

6. The apparatus according to claim 1, further comprising:
a face image searching unit configured to search whether a face image is included in the data, or not,
wherein the erase designating unit designates the intensity value of overwrite erase when the face image is included in the data,
wherein the overwrite erasing unit erases the data through the erasing method according to the designated intensity value when the face image is included in the data.

7. The apparatus according to claim 6,
wherein the overwrite erasing unit changes at least one of a type of overwrite pattern data, the number of overwrite, and combination thereof according to the intensity value.

8. The apparatus according to claim 1, further comprising:
a user request erase designating unit configured to designate, before a job starts, the intensity value of the overwrite erase of unnecessary data after the job is executed,
wherein the overwrite erasing unit applies the intensity value designated by the user request erase designating unit in preference to the intensity value designated by the erase designating unit, and overwrites and erases the data.

9. The apparatus according to claim 8,
wherein the user request erase designating unit accepts setting of an intensity value higher than the intensity value by the overwrite erasing unit.

10. The apparatus according to claim 8,
wherein the overwrite erasing unit changes at least one of a type of overwrite pattern data, the number of overwrite, and combination thereof according to the intensity value.

11. The apparatus according to claim 10, further comprising:
an overwrite erase effectiveness setting unit configured to set whether the overwrite erase of the data is made effective or ineffective;
an update erasing unit configured to update a corresponding FAT without erasing the data; and
a controller that erases the data by not the overwrite erasing unit but the update erasing unit when the overwrite erase is set to be ineffective.

12. The apparatus according to claim 1,
wherein each data includes each data type, and each job unit includes each job type.

13. An image forming method comprising:
designating an intensity value of overwrite erase for each data or each job unit as a method of erasing unnecessary data written in a storage device; and
overwriting and erasing the data by the erasing method according to the designated intensity value.

14. The method according to claim 13,
wherein the designating the intensity value of erase further designates the intensity value of overwrite erase for each given character string included in the data,
wherein whether at least one given character string is included in the data, or not, is searched, and
wherein the data is erased by the erasing method according to the highest intensity value in the intensity values of overwrite erase for each plural given character strings included in the data.

15. The method according to claim 14,
wherein the character string can be arbitrarily added.

16. The method according to claim 14,
wherein the character string includes at least one of secret, secrecy, and confidential.

17. The method according to claim 16,
wherein the overwrite erasing changes at least one of a type of overwrite pattern data, the number of overwrite, and combination thereof according to the intensity value.

18. The method according to claim 13,
wherein the designating the intensity value of erase designates the intensity value of overwrite erase when a face image is included in the data,
wherein whether the face image is included in the data, or not, is searched, and
wherein the data is erased through the erasing method according to the designated intensity value when the face image is included in the data.

19. The method according to claim 18,
wherein the overwrite erasing changes at least one of a type of overwrite pattern data, the number of overwrite, and combination thereof according to the intensity value.

20. The method according to claim 13, further comprising:
before a job starts, designating the intensity value of the overwrite erase of unnecessary data after the job is executed,
wherein the overwrite erasing applies the intensity value designated by the user in preference to the intensity value designated by the designating the intensity value of erase, and overwrites and erases the data.

21. The method according to claim 20,
wherein the designating the intensity value by the user accepts setting of an intensity value higher than the intensity value by the overwrite erase.

22. The method according to claim 20,
wherein the overwrite erasing changes at least one of a type of overwrite pattern data, the number of overwrite, and combination thereof according to the intensity value.

23. The method according to claim 22, further comprising:
setting whether the overwrite erase of the data is made effective or ineffective;
updating a corresponding FAT without erasing the data; and
updating the FAT corresponding to the data without executing overwrite erase on the data when the overwrite erase is set to be ineffective.

24. The method according to claim 13,
wherein each data includes each data type, and each job unit includes each job type.

25. An image forming system having an image forming apparatus, and an information processing device that communicates with the image forming apparatus,
wherein the information processing device comprises:
an erase designating unit configured to designate an intensity value of overwrite erase for each data or each job unit as a method of erasing unnecessary data that is written in a storage device; and
a transmitting unit configured to transmit information designated by the erase designating unit, and
wherein the image forming apparatus comprises:
an receiving unit configured to receive the information transmitted; and
an overwrite erasing unit configured to overwrite and erase the data according to the designated intensity value by the erasing method.

26. The system according to claim 25,
wherein each data includes each data type, and each job unit includes each job type.
